(19) United States
(12) Patent Application Publication
(10) Pub. No.: US 2012/0309611 A1
(43) Pub. Date: Dec. 6, 2012

(54) METHOD FOR PRODUCING A CATALYST FOR CRACKING ORGANIC CARBON COMPOUNDS

(75) Inventor: Eberhard Krause, Hohen Neuendorf (DE)

(73) Assignee: Krause-Rohm-Systeme AG, Munchen (DE)

(21) Appl. No.: 13/574,972

(22) PCT Filed: Jan. 28, 2011
(86) PCT No.: PCT/EP2011/051223

§ 371 Date: Jul. 24, 2012

(30) Foreign Application Priority Data
Jan. 29, 2010 (EP) 10152135.9

(51) Int. Cl. B01J 21/16; B01J 20/04; C01B 3/22

(52) U.S. Cl. 502/80; 252/373

(57) ABSTRACT

The invention relates to a method for producing a catalyst for cracking organic carbon compounds, said method comprising the following steps: a) producing an aqueous suspension comprising red mud and at least one calcium salt, b) heating the suspension to a temperature between 25° C. and 78° C., and c) removing at least most part of an aqueous phase from a solid product mixture produced in step b), said solid product mixture comprising the catalyst. The invention further relates to a catalyst and to a method for cracking organic carbon compounds.

The invention relates to a method for producing a catalyst for cracking organic carbon compounds, to a catalyst for cracking organic carbon compounds as well as to a method for cracking at least one organic carbon compound by means of such a catalyst.

In the petroleum processing, hydrocarbons of longer chain length are cleaved to hydrocarbons of shorter chain length with the aid of catalysts. This is required since more short-chain hydrocarbons are needed than are contained in the petroleum. The same applies to cracking of longer-chain hydrocarbons as they for example occur in biomass. The composition of petroleum can be very different according to origin and includes very different substituted and unsubstituted hydrocarbons such as for example alkanes, cycloalkanes, aromatics, naphthenic acids, phenols, resins, aldehydes and organic sulfur compounds. In comparison, biomass substantially includes complex carbohydrates as cellulose, starch, lignin, lingocellulose or hemicellulose as well as fats and proteins. Therein, catalytic cracking methods offer various advantages over the thermal methods because they usually require lower temperatures or lower pressures and proceed with higher reaction speeds.

Short-chain, unsaturated hydrocarbons such as ethene and propene are also of high interest to the chemical industry because they are required for producing plastics. Therein, these short-chain alkenes are obtainable not only from light and heavy oil, but also from corresponding alkanes like ethane, propane or butane.

From DE 10 2007 058 394 A1, a method for producing fuels from biomasses can be gathered. Various zeolites and metals from the group of Ni, Pd, Pt, Co, Rh, Ir, Fe, Ru, Os, Cu, Zn, Mo and W are provided as heterogeneous catalysts.

The circumstance that they are comparatively expensive and are quickly poisoned and deactivated by tar formation in particular at low temperatures up to about 450° C., is to be considered as disadvantageous in the known catalysts.

Therefore, there is a need of catalysts, which are suitable also as low-cost one-way or disposable catalysts for so-called “single-pass catalytic conversions” and by which organic carbon compounds can be more inexpensively cracked.

According to the invention, the object is solved by a method according to claim 1 for producing a catalyst for cracking organic carbon compounds, by a catalyst according to claim 8 for cracking organic carbon compounds as well as by a method according to claim 9 for cracking at least one organic carbon compound by means of such a catalyst.

In a method according to the invention for producing a catalyst for cracking organic carbon compounds, at least the steps of a) producing an aqueous suspension including red mud and at least one calcium salt, b) heating the suspension to a temperature between 25° C. and 78° C., and c) separating at least most part of an aqueous phase from a solid product mixture produced in step b), wherein the solid product mixture includes the catalyst, are performed. In this manner, a catalyst is obtained, which is suitable as a low-cost disposable catalyst also for so-called “single-pass catalytic conversions”, and by which organic carbon compounds can be more inexpensively cracked.

In the aluminum production according to the Bayer process, Al₂O₃ is dissolved out of finely milled bauxite with the aid of caustic soda lye. After seeding with crystallization nuclei, pure Al(OH)₃ (gibbsite) is precipitated from the sodium aluminate solution obtained therein, from which metallic aluminum is finally obtained by electrolysis. There remains a mixture, which chemically considered is mainly composed of iron oxides and hydroxides, respectively, titanium oxides, alumina residues, quartz sand, calcium oxide, sodium oxide as well as residual caustic soda lye. Due to its red color caused by iron(III) oxide, this residue is referred to as red mud.

Therein, according to the quality of the used bauxite, 1 to 1.5 tons of red mud arise to each produced ton of aluminum as a non-avoidable attendant. Therefore several millions of tons of red mud arise each year, which present a serious environmental and disposal problem together with the already present waste of red mud. Therein, the main problem is the high alkalinity of the red mud due to its content of caustic soda lye, which usually has pH values between 11 and 14. Moreover, toxically acting aluminum ions together with iron compounds present a great danger to the ground water and additionally impede environmentally compatible storage.

Therefore, the disposal of the red mud is substantially effected by storage in sealed disposal sites. The caustic soda lye exiting on the floor of the disposal site is collected and returned into the Bayer process. However, this form of storage is costly and expensive since large disposal site areas and plants are required, and high costs arise for the transport of the red mud. Additionally, the long-term costs arising by the deposition can only hardly be calculated and present an additional economical problem. At present, disposal site stocks with about 1.5 billions of tons of red mud exist. To this, about 50 millions of tons of red mud are added per year.

Thus, the disposal costs can be greatly reduced since the red mud considered as a waste product up to now can be converted into a usable catalyst with the aid of the invention and be used for obtaining reusable materials within the scope of cracking methods.

Therein, preferably, a calcium oxide and/or a calcium hydroxide are used as the calcium salt, wherein burnt lime, white lime and/or slaked lime are particularly preferred. Basically, all of the calcium salts can be used within the scope of the method according to the invention, wherein water-soluble calcium salts usually allow for better yields. As the water-soluble calcium salts, there are for example possible: calcium acetate, calcium chloride, calcium bromide, calcium nitrate, calcium phosphates and the hydrates thereof, respectively, calcium chloride, calcium sulfate, calcium lactate, calcium malate, calcium citrate and/or calcium nitrate. By calcium salts not or difficultly soluble in water, within the scope of the invention, such salts are understood that are soluble in water less than 0.1% by weight (1 g/l) at 20° C. Such calcium salts are e.g. calcium hydroxy phosphate (Ca₅[OH(PO₄)₃]) and hydroxyapatite, respectively, calciumfluorophosphate (Ca₅[F(PO₄)₃]) and fluorapatite, respectively, fluorine-doped hydroxyapatite of the composition Ca₅(PO₄)₃(OH,F) and calcium fluoride (CaF₂) and fluorite, respectively, hydroxyapatite, fluorapatite, fluorspar as well as other calcium phosphates such as di-, tri- or tetracalciumphosphate (Ca₂P₂O₇, Ca₃(PO₄)₂, Ca₄P₂O₉, oxyapatite (Ca₁₀(PO₄)₆O) or non-stoichiometric hydroxyapatite (e.g. Ca_{5 1/2}(x+y)(PO₄)₃₋ₓ(HPO₄)×(OH)). Carbon containing calcium phosphates, calcium hydrogen phosphate (e.g. Ca(HPO₄)*2 H₂O) and octacalciumphosphate are also suitable. The use of anhydrous calcium salts is possible, but not required, since the reaction is performed in aqueous medium.

By a temperature between 25° C. and 78° C., within the scope of the invention, temperatures of 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., and/or 78° C. as well as corresponding intermediate temperatures are to be understood, wherein the temperature principally can be varied once or several times in the specified temperature range during step b).

By a suspension, within the scope of the present invention, a heterogeneous material mixture of a liquid and solids finely distributed therein is to be understood. Depending on the added calcium salt, it can first be crushed. Red mud itself usually is already present in finely dispersed form and basically can be used without further process steps. Depending on the composition of the red mud and the calcium salt, in step a), it can be provided that the red mud is first homogenized and optionally transferred into a pumpable and/or sliceable state by addition of corresponding amounts of liquid. Furthermore, it can be provided that the calcium salt is first dissolved and/or suspended in a corresponding amount of liquid. Basically, the red mud and/or the calcium salt can first be heated separately from each other and subsequently mixed with each other in the heated state. For example, the red mud can first be mixed with water, heated to a temperature between 42° C. and 49° C. or to a temperature of at least 50° C., in particular to at least 52° C. and/or at most 69° C., and subsequently be mixed with the dissolved and/or suspended calcium salt.

Basically, the reaction can be performed without addition of humic acid or humic acid derivatives and thereby free of humic acid, whereby further cost savings arise.

Therein, the invention is based on the realization that within the temperature range between 25° C. and 78° C., clay formation is effected in that the minerals contained in the red mud react with calcium with mineral new formation to a swelling clay like calcium aluminate clay mud. As products mostly calcium and sodium aluminates formed from the aluminum compounds contained in the red mud as well as goethite formed from the iron oxides and hydroxides contained in the red mud. The main reactions proceeding therein are the formation of katoid:

3 Ca(OH)₂+2 Al₂O₃+3 H₂O->Ca₃Al₂[(OH)₄]₃

as well as the conversion of hematite to goethite:

Fe₂O₃+H₂O->2 FeO(OH).

Due to the conversion of hematite, the reaction is associated with a color change from red to yellow/brown. Therein, in contrast to the prior art, release of NaOH electrostatically bound to Fe and Al minerals, which therefore can be virtually quantitatively separated, occurs. The alkaline portion present in the red mud is thus not additionally bound, but can be separated from the remaining, substantially iron containing reaction products in the form of caustic soda lye together with the calcium/sodium aluminates—for example by pressing out—in fast, simple and virtually quantitative manner. Therein, it is to be emphasized that not only the bound caustic soda lye, but all of the alkaline compounds are reduced with the aid of the method according to the invention due to the chemical conversion of the iron oxides and silicates contained in the red mud. By the reduction of the alkaline portion, the further reworking is also facilitated such that various reusable materials become accessible. The aluminate yield can be controlled via the added amount of calcium—as apparent from the reaction equation. By addition of lower amounts of calcium, a higher iron ore yield can be achieved. Additionally or alternatively to red mud, the reaction can also be performed with bauxite or other iron containing ores.

At temperatures below 25° C., the desired calcium aluminate clay mud does not arise or not in economically acceptable speeds and yields. In comparison, above 78° C., differing iron, calcium and aluminum compounds arise, which do not have the required catalytic properties and do not allow comprehensive utilization of red mud. In summary, the catalyst is inexpensively produced from a “waste material” at temperatures considerably below 100° C. in aqueous phase. Due to its very inexpensive production from a nearly unlimitedly present “waste material” of aluminum production, the catalytically active product mixture can readily be used in passage or as a one-way catalyst.

In an advantageous development of the invention, it is provided that in step a) a pH value of the suspension is adjusted to at least 10, in particular to at least 12, and/or a weight ratio between the red mud and the water is adjusted to a value between 0.8 and 1.2. Hereby, a particularly high yield of the above mentioned, catalytically active reaction products is achieved. By a pH value of at least 10, therein, in particular values of 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9 and/or 14.0 are to be understood. Therein, in particular pH values between 12.0 and 12.5 have manifested as particularly reaction promoting.

In a further advantageous development of the invention, it is provided that in step a) a weight ratio between the calcium salt and the red mud is adjusted to a value of at least 0.15, in particular of at least 0.20, and/or a molar ratio between calcium and aluminum is adjusted to a value between 1.6 and 2.0, in particular to 1.8. Hereby, particularly high conversion rates and yields are achieved.

In a further advantageous development of the invention, it is provided that in step b) the suspension is heated to a temperature between 40° C. and 75° C., in particular to a temperature between 42° C. and 49° C., in particular between 43° C. and 48° C. and/or to a temperature between 52 ° C. and 68° C. and preferably to a temperature of 65° C. By bringing the suspension to a temperature between 40° C. and 49° C., in particular between 43° C. and 48° C., during step b), a quantitative or at least approximately quantitative conversion of the hematite present in the red mud to goethite is achieved. Alternatively, it can be provided that the temperature of the suspension is maintained between 50° C. and 75° C., in particular between 52° C. and 68° C. during step b), since hereby particularly short reaction times are achieved with further good conversion rates. However, at temperatures above 69° C., formation of sodium silicates increasingly occurs, while the inventively sought conversion of the various iron oxides constituting the main component of red mud with 35% to 60% on average to goethite greatly decreases and finally virtually does no longer occur at temperatures above 78° C.

In a further advantageous development of the invention, it is provided that the suspension is heated between 10 minutes and 6 hours, in particular between 30 minutes and 2 hours and preferably between 1 hour and 2 hours in step b). In this manner, conversion of the educts as complete as possible can be ensured.

In a further advantageous development of the invention, it is provided that the liquid phase is separated from the solid product mixture including the catalyst by means of a filter press and/or a chamber filter pres and/or a separator in step c). This constitutes a particularly simple and inexpensive method for obtaining the catalyst. Therein, the separation principally can be performed continuously and/or discontinuously.

In a further advantageous development of the invention, it is provided that the solid product mixture including the catalyst is dried and/or the catalyst is purified after step c). Hereby, the catalyst can be adapted to its later purpose of use.

A further aspect of the invention relates to a catalyst for cracking organic carbon compounds, wherein this catalyst is obtainable according to the invention by a method according to anyone of the preceding embodiments. In this manner, a catalyst is obtainable, which is suitable as inexpensive disposable catalyst also for so-called “single-pass catalytic conversions”, and by which organic carbon compounds can be more inexpensively cracked. The features presented in connection with the method according to the invention and the advantages thereof correspondingly apply to the catalyst according to the invention.

A further aspect of the invention relates to a method for cracking at least one organic carbon compound by means of a catalyst, which is produced and/or obtainable by a method according to anyone of the preceding embodiments, wherein at least the steps of a) mixing the catalyst with the at least one organic carbon compound, b) heating the mixture produced in step a), and c) separating at least one gaseous reaction product from at least one solid reaction product are performed. In this manner, organic carbon compounds can be more inexpensively cracked using the catalyst according to the invention. Therein, the catalyst can be used as a disposable catalyst within the scope of so-called “single-pass catalytic conversions”. The features presented in connection with the method according to the invention or the catalyst according to the invention and the advantages thereof correspondingly apply to the method according to the invention.

In an advantageous development of the invention, it is provided that in step a) a kerogen and/or coal and/or tar and/or an oil and/or biomass is used as the organic carbon compound and/or that the catalyst and the organic carbon compound are mixed with each other in a weight ratio between 2 and 3, in particular of 2.5. Hereby, particularly high yields are achieved. Therein, embedding of the organic carbon compounds in the finely dispersed catalyst as homogeneous as possible has manifested as advantageous for a uniform and fast conversion.

In a further advantageous development of the invention, it is provided that the mixture is heated to a temperature between 250° C. and 450° C., in particular between 280° C. and 400° C. and/or for a period of time between 30 minutes and 2 hours, in particular between 40 minutes and 1 hour in step b). With the aid of the catalyst according to the invention, thus, biomass gasification at particularly low temperatures can be performed. In comparison, biomass gasifications known from the prior art have to be performed at temperatures of at least 750° C.-800° C. or suffer great tar formation. A further substantial difference is in that the biomass gasification proceeds free of tar and without appreciable carboxylic acid formation (in particular without acetic acid and formic acid formation) despite the low temperatures of at most 450° C. due to the catalytic properties of the product mixture. In comparison, in biomass gasification processes known from the prior art, usually large amounts of tar arise even at substantially higher temperatures, which result in various considerable problems.

In the pyrolysis in the low temperature range, reduction and oxide new formation of the mineral constituents, carbonate formation with minerals in the CO₂ atmosphere (30%) and decomposition of the organic wood constituents (cellulose+hemicelluloses) in presence of the heterogenic catalyst (including: Fe, K and Ti ions) occur. Important proceeding reactions can be schematically explained with the following exemplary reaction equations:

Ca₃Al₂[(OH)₄]₃ (katoid) remains not decomposed;

2 FeO(OH)->Fe₂O₃ (Fe₃O₄)+H₂O (goethite reacts to maghemite and/or magnetite)

NaOH+CO₂->Na₂CO₃

SiO₂+NaOH+CO₂->Na silicates

Wood or Biomass Gasification:

C₅₀H₆O₄₃+n H₂O->CO (30%)+H₂ (30%)+CHₙ (10%) (exothermic)

(Therein, “C₅₀H₆O₄₃” corresponds to an average wood composition and only serves for illustration).

In a further advantageous development of the invention, it is provided that in step b) the mixture is heated with oxygen exclusion and/or is shielded by a protective gas curtain, in particular a CO₂ curtain, upon heating. Hereby, undesired oxidation of the various educts and products is avoided on the one hand, the carbonate formation of various mineral components can be specifically controlled on the other hand.

In a further advantageous development of the invention, it is provided that the steps a) to c) are performed continuously and preferably in a counter-flow gasifier. Hereby, the method can be performed particularly economically.

In a further advantageous development of the invention, it is provided that in step c) at least one gaseous reaction product is separated, which includes CO and/or H₂ and/or CH₄, and/or that a magnetic reaction product including at least magnetite and/or maghemite is separated, and/or that a solid non-magnetic reaction product is separated, which includes at least coal and/or a hydrocarbon and/or at least a silicate and/or at least a carbonate and/or an aluminum compound. As the gaseous reaction product, lean gas and/or generator gas (with ca. 40% H₂, 40% CO and 20% CH₄) and/or water vapor can be obtained among other things. The water vapor in turn can be used for energy extraction and/or for heating the mixture produced in step a) in step b) such that the method can be performed in autothermal manner. According to the preceding method steps, for example, charcoal can be obtained from the biomass gasification as the solid non-magnetic reaction product. As the magnetic reaction product, in particular an iron ore including magnetite/maghemite and as the non-magnetic reaction product an iron ore lime fertilizer can be obtained.

In a further advantageous development of the invention, it is provided that the reaction product including CO and/or H₂ and/or CH₄ is used for performing a Fischer-Tropsch process and/or a gas-to-liquid process and/or for operating a heating plant, and/or that the magnetic reaction product is used for producing metallic iron and/or an iron alloy and/or as a mineral fertilizer and/or that the solid non-magnetic reaction product is used as a mineral additive and/or as a soil conditioner and/or clarification agent and/or as a cement additive and/or as a construction material and/or as a mineral fertilizer. Hereby, a particularly extensive reusable material extraction from the red mud considered as waste up to now is allowed, which was not possible without the production of the catalyst according to the invention. Therein, the method can readily be optimized for a lean, generator and/or synthesis gas production. The gaseous products in turn can be utilized for the subsequent production of methanol, Fischer-Tropsch and/or gas-to-liquid products in a manner known per se.

In a further advantageous development of the invention, it is provided that the solid reaction product separated in step c) is used as a filter element, in particular for filtering vegetable oil and/or polluted water. Hereby, various fuels or diesel substitutes (e.g. biodiesel, winter biodiesel and the like) are accessible in simple and inexpensive manner.

Further features of the invention are apparent from the claims, the embodiments as well as based on the drawings. The features and feature combinations mentioned above in the description as well as the features and feature combinations mentioned below in the embodiments are usable not only in the respectively specified combination, but also in other combinations or alone, without departing from the scope of the invention. Therein, it shows:

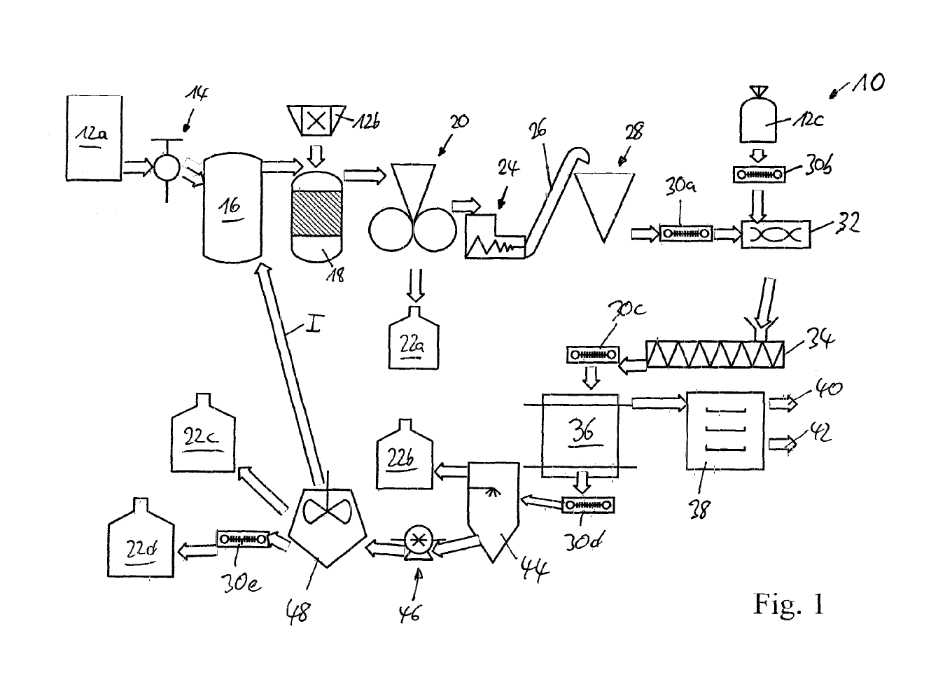

FIG. 1 a schematic illustration of a device according to the invention for performing a method for utilizing red mud;

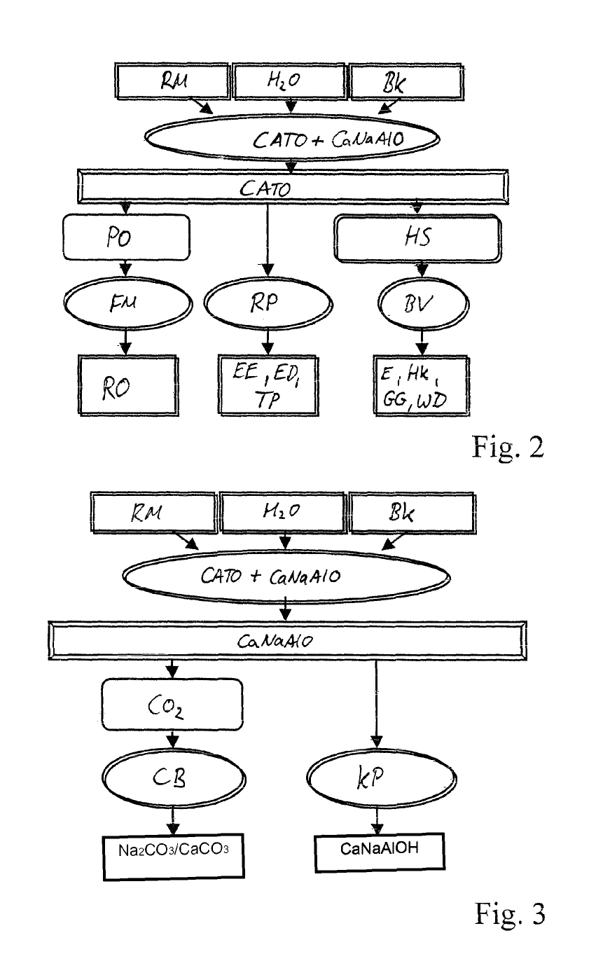

FIG. 2 a flow diagram of a further embodiment of the method according to the invention;

FIG. 3 a flow diagram of a further embodiment of the method according to the invention; and

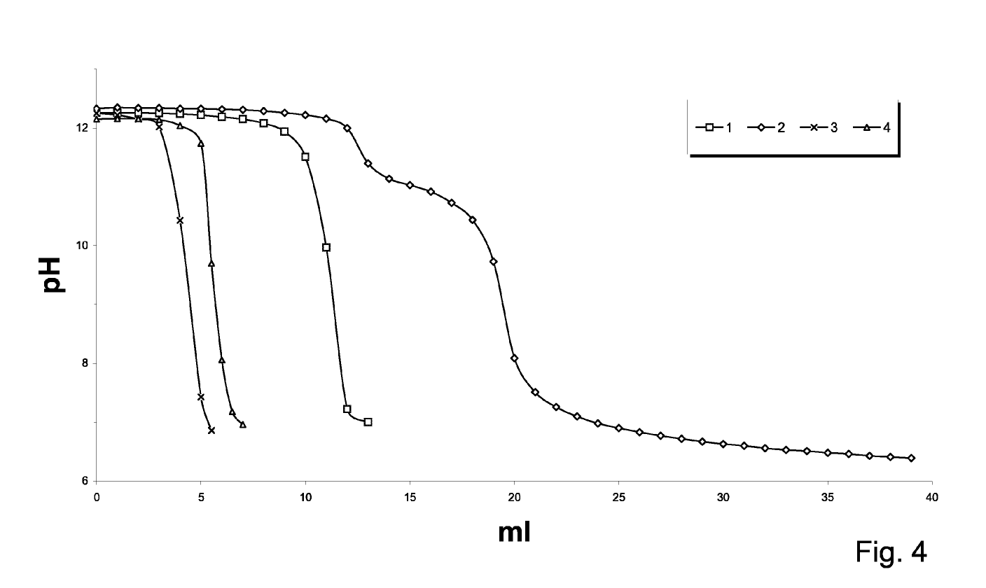

FIG. 4 several titration curves.

FIG. 1 shows a schematic illustration of a device 10 according to the invention for performing a method for producing a catalyst for cracking organic carbon compounds. The device 10 includes a storage container 12a for storing red mud. From the storage container 12, the red mud is conveyed to a conditioner 16 through a weighing and transporting device 14 formed as a screw scale with an adjustable flow-rate amount of 160-250 kg/h with sliceable consistence and there mixed with water and caustic soda lye, which is returned according to arrow I from later process steps. Therein, a pH value of the red mud is adjusted to at least 10, in particular to at least 12, wherein a weight ratio between the red mud and the water is adjusted to a value between 0.8 and 1.2, in particular to about 1.0. From the conditioner 16, the red mud is pumped into a reactor 18 and mixed with burnt lime, whereby an aqueous suspension arises, which includes red mud and calcium salt. The burnt lime is therein stored in a further storage container 12b and conveyed into the reactor 18 in such amounts that a weight ratio between the calcium salt and the red mud is adjusted to a value of at least 0.15, in particular of at least 0.20, or a molar ratio between calcium and aluminum is adjusted to a value between 1.6 and 2.0, in particular to 1.8.

The suspension is heated to a temperature between 25° and 78° C., in particular to a temperature between 60° C. and 68° C., for a period of time between 20 minutes and about 4 hours in the reactor 18. Therein, a temperature of about 65° C. has shown to be optimal for recovery of the caustic soda lye present in the suspension as complete as possible. Therein, an iron-rich calcium aluminate clay mud (CATO) arises in the solid phase, which constitutes a substantial component of the catalyst according to the invention. In the liquid phase, in comparison, calcium/sodium aluminates are formed. The color of the suspension changes from red to yellow/brown during the reaction. Furthermore, the viscosity increases since water is bound as water of crystallization of various salts.

After elapse of the reaction time, the developed product mixture is transferred from the reactor 18 into a separating unit 20 formed as a chamber filter press, in which the liquid phase is at least widely separated from the solid phase including the catalyst. The liquid phase including the calcium/sodium aluminate lye (composition ca. 96% NaOH, 1.8% Al₂O₃, 1.2% SiO₂) is collected in a collecting container 22a as a reusable material. Therein, the separating unit 20 is adapted to separate between 200 l/h and 400 l/h of liquid phase.

The filter cake with the solid product mixture is transported into a fine disintegrator 28 via a coarse disintegrator 24 and a transport belt 26 and disintegrated into particles with diameters of about 2.0 to 2.5 mm. The clay mineral mixture is transported into a mixing device 32 formed as a double shaft mixer via a transporting device 30a formed as a rotary star valve with a temperature of less than 65° C. and a flow-rate between 200 l/h and 400 l/h and mixed with chips. The chips representing biomass with very different organic carbon compounds are stored in a further storage container 12c and also transported into the mixing device 32 with a transporting device 30b formed as a rotary star valve with a temperature of less than 65° C. and a flow-rate between 200 kg/h and 400 kg/h.

Via a transporting device 34 formed as a screw conveyor and a further transporting device 30c formed as a rotary star valve, the catalytically active product mixture (CATO) and the chips are filled into a biomass gasifier 36 preferably capable of being passed, with a temperature of about 105° C. and heated to a temperature between 250° C. and 450° C., in particular between 280° C. and 400° C., preferably with oxygen exclusion. The oxygen exclusion can for example be achieved by means of a CO₂ protective gas curtain. The biomass gasification can basically be performed continuously and/or discontinuously. In the biomass gasification, various reductions, oxide new formations and decompositions of the organic wood constituents (cellulose, hemicelluloses etc.) proceed in presence of the heterogeneous catalyst (catalytically particularly effective: Fe, K and Ti ions). Due to the CO₂ content of the reaction atmosphere, in addition, carbonate formation occurs.

As the gaseous reaction products, there arise generator gas (with a composition of about 40% H₂, 40% CO and 40% CH₄), CO₂ and water vapor. Therein, the yield of the gaseous products is regularly at about 70% of the employed chip dry matter. The generator gas is separated and supplied to a block heating plant 38, by means of which electrical current 40 and process heat 42 are extracted. This allows operating the entire process in autothermal manner or the entire device 10 in self-supporting manner.

The solid reaction products of the biomass gasification substantially include charcoal, iron minerals, silicates, titanium oxide and lime minerals. The charcoal yield is regularly at about 30%-40% of the employed chip dry matter. Therein, it is to be emphasized that the biomass gasification proceeds both at these low temperatures and virtually tar-free due to the catalytic and reaction promoting properties of the CATO. The solid reaction products are transported with a temperature below 320° C. and a rate between 200 kg/h and 400 kg/h over a further transporting device 30d formed as a rotary star valve into a quenching container 44 filled or fillable with water. Via density separation, the light charcoal can be separated and collected in a collecting container 22b. The heavier mineral materials are conveyed into a sedimenter 48 via a transporting device 46 formed as a screw pump, in which separation and recirculation of caustic soda lye (arrow I) as well as density separation of the mineral materials into a lighter fraction with a specific gravity of about 3 g/cm³ and a heavier fraction with a specific gravity of about 5 g/cm³ occur. The lighter fraction is transported into a further collecting container 22c and includes a mineral mixture usable as a iron lime mineral fertilizer, which is substantially composed of silicates, titanium oxide and lime minerals. This mineral mixture optionally can be further processed with charcoal powder to Terra Preta, wherein the charcoal powder can be naturally obtained from the biomass gasification. The heavier fraction is transported via a further transporting device 30e formed as a rotary star valve into a further collecting container 22d and substantially includes iron ore.

Thus, all of the end products of the process constitute reusable materials, which are obtainable from the red mud considered as waste material up to now in environmentally neutral manner.

FIG. 2 shows a flow diagram of a further embodiment of the method according to the invention. Therein, first, an aqueous suspension of red mud (RM), water (H₂O) and burnt lime (BK) is produced as a calcium salt and heated to a temperature between 42° C. and 78° C. Herein, the above explained product mixture of solid, iron-rich calcium aluminate clay mud (CATO) and liquid Ca/Na aluminate lye (CaNaAlO) is formed. The CATO is subsequently separated from the liquid phase.

In a first process branch, the obtained CATO is mixed with a vegetable oil (PO)—e.g. soya oil, jatropha oil and the like—and used as a filter mass (FM). Hereby, refined oils (RO)—also bio-oils—as well as fuel and diesel substitutes can be obtained as reusable materials.

In a second process branch, the CATO is subjected to a reduction process (RP), whereby iron ore (EE), iron lime fertilizer (ED) and—after mixing the iron lime fertilizer with charcoal powder—Terra Preta (TP) are accessible.

In a third process branch, the CATO is—as above described—mixed with chips (HS) and used for biomass gasification (BV). Hereby, energy (E) in the form of electrical current and/or process heat, tar-free charcoal (HK), generator gas (GG) and water vapor (WD) are obtainable. Alternatively or additionally, the generator gas can be used for performing a Fischer-Tropsch process and/or a gas-to-liquid process with the corresponding advantages.

FIG. 3 shows a flow diagram of a further embodiment of the method according to the invention. First, analogically to the preceding embodiment, an aqueous suspension is produced from red mud (RM), water (H₂O) and burnt lime (BK) as the calcium salt and heated to a temperature between 42° C. and 78° C. Herein, the above explained product mixture of solid, iron-rich calcium aluminate clay mud (CATO) and liquid Ca/Na aluminate lye (CaNaAlO) is formed. In the present embodiment, the Ca/Na aluminate lye is subsequently separated from the solid phase, i.e. from the CATO.

In a first process branch, the Ca/Na aluminate lye is mixed with CO₂, thereby initiating carbonate formation (CB). Hereby, soda (Na₂CO₃) and lime (CaCO₃) are obtained as reusable materials. Therein, the CO₂ can for example be derived from the above described biomass gasification, whereby the process can be performed in particularly economical and environmentally neutral manner.

In a second process branch, the Ca/Na aluminate lye is concentrated (KP), whereby a concentrated Ca/Na aluminate lye (CaNaAlOH) with application-specific properties is obtainable. For example, the Ca/Na aluminate lye can again be used within the scope of the Bayer process, whereby the otherwise arising costs for the production of this lye are cancelled.

In a further embodiment, with the aid of a device 10 adapted to a flow-rate amount of 100000 t/a red mud, from:
100000 t/a red mud;
20000 t/a burnt lime;
40000 t/a chips (35% of water); and
50000 t/a water,

in the above described manner
56400 t/a iron ores;
58800 t/a iron lime mineral fertilizer;
38100 t/a Ca/Na aluminate lye;
7280 t/a charcoal;
13104 t/a generator gas;
5616 t/a CO₂; and
30700 t/a water vapor

are obtained.

In a further embodiment, from:
330 t CATO; and
1000 t vegetable oil

in the above described manner
900-930 t refined oil; and
430-400 t CATO mixed with organic residual compounds are obtained. For example, the vegetable oil is derived from pressing oil plants. The mixing ratio of CATO to raw vegetable oil usually is about 1:3. The CATO mixed with residues of organic vegetable oil portions can subsequently be converted to the corresponding raw materials/minerals in the above described manner analogically to the processing of wood chips. The organic vegetable oil portions can be converted to generator gas and subsequently be used for obtaining electrical current (20%) and process heat (80%).

In summary, red mud as a starting material provides with the aid of the method according to the invention and with the aid of the device 10 according to the invention, respectively, among other things:
an inexpensive catalyst for cracking organic carbon compounds;
iron ores, iron titanium ores and “fine ore” for the smelting of iron;
charcoal and generator gas, which can for example be utilized in block heating plants for obtaining electrical current and process heat;
iron lime mineral fertilizer and Terra Preta as a soil conditioner for neutralizing acid soils as well as for obtaining agricultural land;
caustic soda lye and aluminate lye, which are usable as disinfectants or detergents, as clarification adjuvant or for waste water purification in the chemical industry, in breweries, in the aluminum industry and the like;
clay minerals and silicates usable as brick building material, aggregate for the road construction, for synthetic fiber production, as sealing masses and the like in the construction material industry; and
creating CO₂ certificates by binding CO₂ in the form of soda and/or lime.

FIG. 4 shows graphical illustrations of several titration curves, in which the pH value of four samples “1” to “4” explained in more detail below is plotted versus the added volume of acetic acid (glacial acetic acid, CH₃COOH).

For the first sample “1”, the CATO described in the preceding examples, which was obtained from the reaction of a mixture of red mud with 15% by weight of CaO, was pressed out with the aid of a chamber filter press. Moreover, three further samples of red mud were produced, wherein the sample “2” was only composed of red mud and the further samples included 10% by weight (sample “3”) and 15% by weight (sample “4”), respectively, of added burnt lime (CaO) besides red mud. Subsequently, by addition of water, a ratio of dry matter:liquid of 1:2 as well as a pH value of 12.4 were adjusted in the three samples “2” to “4”.

The three samples “2” to “4” were heated to a temperature of about 48° C. while stirring for 2 hours, wherein a color change from red to yellow/brown was observed in the two samples “3” and “4” mixed with burnt lime. After cooling and settling of the solid phase, in addition, it was recognizable that with increasing burnt lime portion, the liquid binding greatly increased such that the liquid was bound into the developed clay mud largely with the sample “3” originally containing 10% by weight of burnt lime and virtually completely with the sample “4” originally containing 15% by weight of burnt lime.

The liquid phases of the samples “2” to “4” were also filtered off and titrated against acetic acid together with the filtrate of sample “1”. In FIG. 4, the titration curve of the press lye denoted as sample “1” is identified with squares, the titration curve of the sample “2” denoted as barrel lye is identified with rhombs, the titration curve of the filtrate of sample “3” is identified with crosses and the titration curve of the filtrate of sample “4” is identified with triangles.

As becomes clear from FIG. 4, the progression of the titration curve of sample “1” substantially corresponds to the progression of pure caustic soda lye. Analogically to sample “1”, the titration curves of the samples “3” and “4” also correspond to the titration curve of pure caustic soda lye due to the clay formation reactions. In comparison, the barrel lye “2” obtained from “pure” red mud shows a substantially higher buffer capacity as well as an additional equivalence point, which is attributable to the buffer effect of ion exchanger like compounds in the red mud (e.g. Ca—Na silicates (zeolites), sodalithe, cancrinite, Na—Al silicates and the like).

The parameter values specified in the documents for definition of process and measurement conditions for the characterization of specific properties of the subject matter of invention are to be considered as encompassed by the scope of the invention also within the scope of deviations—for example due to measurement errors, system errors, weighing errors, DIN tolerances and the like.

1. A method for producing a catalyst for cracking organic carbon compounds, in which at least the following steps are performed:
a) producing an aqueous suspension including red mud and at least one calcium salt;
b) heating the suspension to a temperature between 25° C. and 78° C.; and
c) separating at least most part of an aqueous phase from a solid product mixture produced in step b), wherein the solid product mixture includes the catalyst.

2. The method according to claim 1, wherein
in step a), a pH value of the suspension is adjusted to at least 10, in particular to at least 12, and/or that a weight ratio between the red mud and water is adjusted to a value between 0.8 and 1.2.

3. The method according to claim 1, wherein
in step a), a weight ratio between the calcium salt and the red mud is adjusted to a value of at least 0.15, in particular of at least 0.20, and/or a molar ratio between calcium and aluminum is adjusted to a value between 1.6 and 2.0, in particular to 1.8.

4. The method according to claim 1, wherein
in step b), the suspension is heated to a temperature between 40° C. and 75° C., in particular to a temperature between 42° C. and 49° C., in particular between 43° C. and 48° C. and/or to a temperature between 50° C. and 68° C. and preferably to a temperature of 65° C.

5. The method according to claim 1, wherein
in step b), the suspension is heated between 10 minutes and 6 hours, in particular between 30 minutes and 2 hours and preferably between 1 hour and 2 hours.

6. The method according to claim 1, wherein
in step c), the liquid phase is separated from the solid product mixture including the catalyst by means of a filter press and/or a chamber filter press and/or a separator.

7. The method according to claim 1, wherein
the solid product mixture including the catalyst is dried and/or the catalyst is purified after step c).

8. The method according to claim 1 wherein a cracking organic carbon compound is obtained from the steps performed.

9. The method for cracking at least one organic carbon compound by means of a catalyst produced by a method according to claim 1 wherein at least the following steps are performed:
a) mixing the catalyst with the at least one organic carbon compound;
b) heating the mixture produced in step a); and
c) separating at least one gaseous reaction product from at least one solid reaction product.

10. The method according to claim 9, wherein
in step a) a kerogen and/or coal and/or tar and/or an oil and/or biomass is used as the organic carbon compound and/or that the catalyst and the organic carbon compound are mixed with each other in a weight ratio between 2 and 3, in particular of 2.5.

11. The method according to claim 9, wherein
in step b), the mixture is heated to a temperature between 250° C. and 450° C., in particular between 280° C. and 400° C. and/or for a period of time between 30 minutes and 2 hours, in particular between 40 minutes and 1 hour.

12. The method according to claim 9, wherein
in step b), the mixture is heated with oxygen exclusion and/or is shielded by a protective gas curtain, in particular a CO₂ curtain, upon heating.

13. The Met-had method according to claim 9, wherein
the steps a) to c) are performed continuously and preferably in a counter-flow gasifier.

14. The method according to claim 9, wherein
in step c), at least one gaseous reaction product is separated, which includes CO and/or H₂ and/or CH₄, and/or that a magnetic reaction product including at least magnetite and/or maghemite, is separated and/or that a solid non-magnetic reaction product is separated, which includes at least coal and/or a hydrocarbon and/or at least a silicate and/or at least a carbonate and/or an aluminum compound.

15. The method according to claim 14, wherein
the reaction product including CO and/or H₂ and/or CH₄ is used for performing a Fischer-Tropsch process and/or a gas-to-liquid process and/or for operating a heating plant, and/or that the magnetic reaction product is used for producing metallic iron and/or an iron alloy and/or as a mineral fertilizer, and/or that the solid non-magnetic reaction product is used as a mineral additive and/or as a soil conditioner and/or as a clarification agent and/or as a cement additive and/or as a construction material and/or as a mineral fertilizer.

16. The method according to claim 9, wherein
the solid reaction product separated in step c) is used as a filter element, in particular for filtering vegetable oil and/or polluted water.
